(19) United States
(12) Patent Application Publication
(10) Pub. No.: US 2018/0123254 A1
(43) Pub. Date: May 3, 2018

(54) SINGLE-LAYERED END-FIRE CIRCULARLY POLARIZED SUBSTRATE INTEGRATED WAVEGUIDE HORN ANTENNA

(71) Applicants: Ke Wu, Montreal (CA); Yifan Yin, Montreal (CA)

(72) Inventors: Ke Wu, Montreal (CA); Yifan Yin, Montreal (CA)

(21) Appl. No.: 15/627,158

(22) Filed: Jun. 19, 2017

Related U.S. Application Data
(60) Provisional application No. 62/414,433, filed on Oct. 28, 2016.

(51) Int. Cl. H01Q 13/02; H01Q 13/08; H01Q 1/22; H01Q 9/04

(52) U.S. Cl. CPC H01Q 13/0241; H01Q 9/0428; H01Q 1/2283; H01Q 13/085

(57) ABSTRACT

An end fire circularly polarized (CP) substrate integrated waveguide (SIW) horn antenna and a method of manufacturing thereof are described. The antenna includes an input section for receiving radio frequency (RF) waves from a source; and a body extending from the input section for receiving the RF waves from the input section, the body comprising a plurality of radiating units, the plurality of radiating units being configured to radiate circularly polarized waves (CP) in a far field, wherein apertures of the plurality of radiating unit being located along an edge of a planar dielectric substrate, and wherein the horn antenna is in a planar form.

### RELATED APPLICATION

This application is related to U.S. provisional patent application No. 62/414,433, filed Oct. 28, 2016, entitled PLANAR END-FIRE CIRCULARLY POLARIZED SUBSTRATE INTEGRATED WAVEGUIDE HORN ANTENNA, which is incorporated herein by reference.

### FIELD

The present invention relates to antennas, and in particular to single-layered end-fire circularly polarized substrate integrated waveguide horn antennas.

### BACKGROUND

Three-dimensional horn antennas are commonly used in various applications such as communication systems, radar, imaging, and radio astronomy. In these applications, the horn antenna is used either as an independent antenna or as a feeder for its related reflector antenna. Three-dimensional horn antennas are usually bulky, expensive, and difficult to integrate with other components of a system or device.

Circularly polarized (CP) antennas are typically used in satellite and mobile communication systems. CP antennas have certain advantages over linearly polarized antennas. For example, CP antennas are less sensitive to antenna axial rotation and have less delay spread. Planar CP antennas are typically broadside structures. As well, most CP antennas have a complex feed network and a multi-layer substrates topology, which increases the overall cost and dimensions of the antennas.

### SUMMARY

The present disclosure describes a single-layered end-fire CP substrate integrated waveguide horn antenna on a layer of substrate which can, in some configurations, reduce the overall size of the antenna and cost to integrate the antenna. In example embodiments, the antenna comprises a plurality of radiating units for generating CP waves in a far field. The horn antenna is integrated in a layer of substrate and is substantially planar. As the horn antenna is substantially in a planar form, this allows the horn antenna to be integrated in the applications involving substrate integrated circuits (SICs). As well, the number of radiating units of the horn antenna is expandable to achieve a potential higher gain.

According to one aspect, there is provided an end fire circularly polarized (CP) substrate integrated waveguide (SIW) horn antenna that includes an input section for receiving radio frequency (RF) waves from a source; and a body extending from the input section for receiving the RF waves from the input section, the body comprising a plurality of radiating units, the plurality of radiating units being configured to radiate circularly polarized waves (CP) in a far field, wherein apertures of the plurality of radiating unit being located along an edge of a planar dielectric substrate, and wherein the horn antenna is in a planar form.

According to one aspect, there is provided an end fire circularly polarized (CP) substrate integrated waveguide (SIW) horn antenna that includes an input section for receiving radio frequency (RF) waves from a source; and a body extending from the input section and comprising a plurality of radiating units for receiving the RF waves from the input section and radiating corresponding RF waves from respective radiating unit apertures, the plurality of radiating units comprising a first radiating unit for radiating first linearly polarized waves, and a second radiating unit for radiating second linearly polarized waves, wherein at respective radiating unit apertures of the first and second radiating units, the first linearly polarized waves and the second linearly polarized waves have a substantially same amplitude, a phase difference of substantially 90°, and a difference in polarization direction of substantially +/−90°, wherein the input section and the body are formed from a planar dielectric substrate coated with planar conductive layers on opposite sides thereof, two conductive side walls electrically connecting the planar conductive layers, and wherein the radiating unit apertures being located along an edge of the substrate.

Optionally, in any of the preceding aspects, the plurality of radiating units radiating corresponding RF waves from respective radiating unit apertures, the plurality of radiating units comprising a first radiating unit for radiating first linearly polarized waves, and a second radiating unit for radiating second linearly polarized waves, wherein at respective radiating unit apertures of the first and second radiating units, the first linearly polarized waves and the second linearly polarized waves have a substantially same amplitude, a phase difference of substantially 90°, and a difference in polarization direction of substantially +/−90°.

Optionally, in any of the preceding aspects, the first linearly polarized waves are vertically polarized waves.

Optionally, in any of the preceding aspects, the second linearly polarized waves are horizontally polarized waves.

Optionally, in any of the preceding aspects, at least one of the first and second radiating units is an antipodal linearly tapered slot antenna (ALTSA).

Optionally, in any of the preceding aspects, the first radiating unit is adjacent to the second radiating unit.

Optionally, in any of the preceding aspects, the input section and the body are formed from the planar dielectric substrate enclosed by planar conductive layers on opposite sides thereof and two conductive side walls electrically connecting the planar conductive layers.

According to one aspect, there is provided a method of manufacturing an end fire circularly polarized (CP) horn antenna on a substrate having a face side and a bottom side, the method includes covering the face side of the substrate with a face side conductive layer; covering the bottom side of the substrate with a bottom side conductive layer; forming conductive side walls for electrically connecting the face side conductive layer and the bottom side conductive layer; forming a plurality channels by cutting or etching through the face conductive layer, the substrate, and the bottom conductive layer; and forming conductive dividing walls by metalizing two surfaces of each of the channels, wherein the top and bottom conductive layers, the conductive side walls, the conductive dividing walls, and the substrate form the horn antenna comprising a plurality of radiating units, wherein plurality of radiating units radiate circularly polarized waves in a far field, and wherein the horn antenna is in a planar form.

### BRIEF DESCRIPTION OF THE DRAWINGS

Reference will now be made, by way of example, to the accompanying drawings which show example embodiments of the present disclosure, and in which:

FIG. 1 is a top view of an example single-layered end-fire CP substrate integrated waveguide (SIW) horn antenna, according to example embodiments;

FIG. 2 is a side view of the example single-layered end-fire CP SIW horn antenna of FIG. 1;

FIG. 3 is a front end view of the example single-layered end-fire CP SIW horn antenna of FIG. 1; and

FIG. 4 is a diagram showing power division of the example single-layered end-fire CP SIW horn antenna of FIG. 1.

Similar reference numerals may have been used in different figures to denote similar components.

### DETAILED DESCRIPTION

The structure, shape, and manufacture of example embodiments are discussed in detail below. The specific examples discussed are merely illustrative of specific ways to make and use embodiments of the invention, and do not limit the scope of the invention.

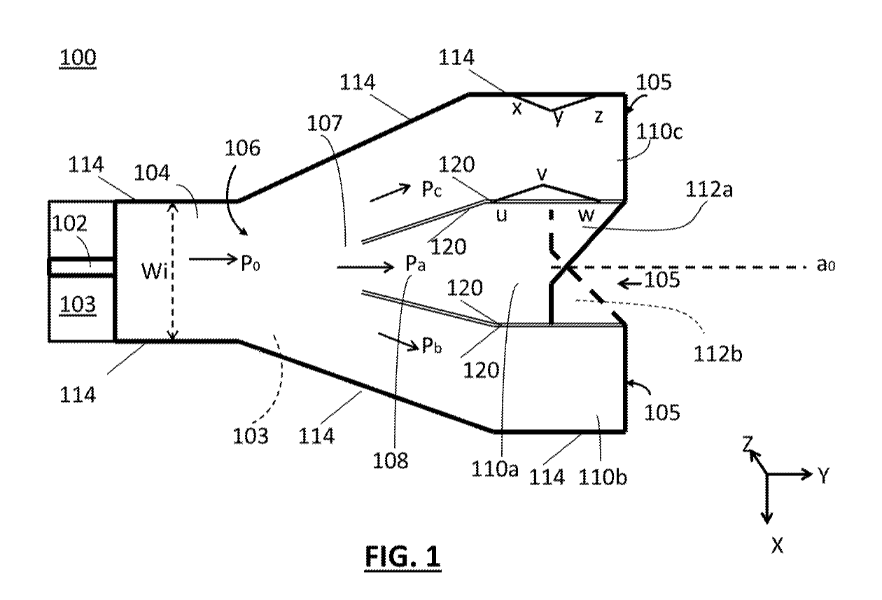

FIGS. 1-3 illustrate an example single-layered end-fire CP SIW horn antenna 100 (“horn antenna 100”). Substrate integrated waveguide (SIW) is an integrated waveguide-like structure.

As illustrated in FIGS. 1-3, horn antenna 100 includes a single integrated substrate layer 103. The shape and structure of the horn antenna 100 may be varied as long as the horn antenna 100 is in a planar form and includes a single integrated substrate layer.

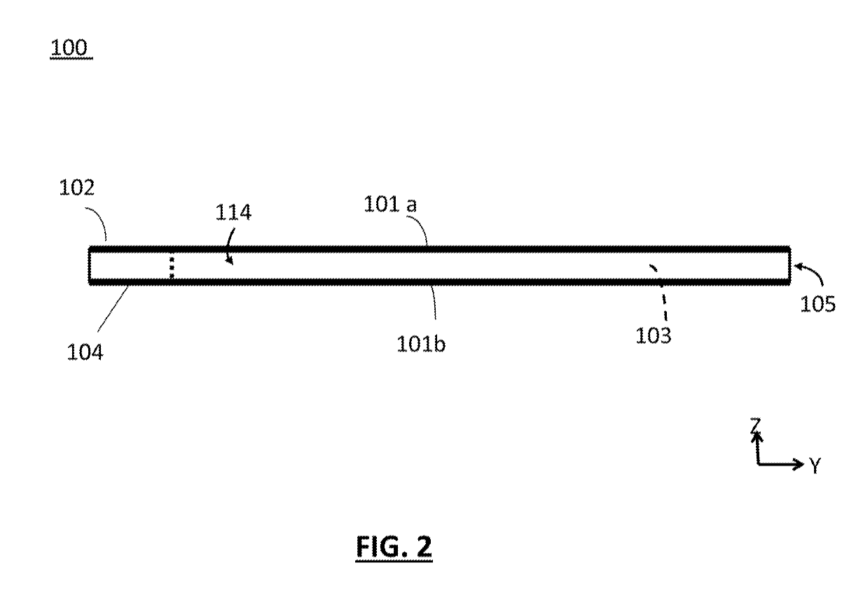

In some example embodiments, the horn antenna 100 includes a metallic top layer 101a and a metallic bottom layer 101b (FIG. 2), and two metallic side walls 114. The metallic top layer 101a, the metallic bottom layer 101b, and two metallic side walls 114 enclose a layer of dielectric substrate 103 therein. The two metallic side walls 114 are electrically connected with the metallic top layer 101a and the metallic bottom layer 101b. The two metallic side walls 114 may be formed by two rows of metallic via arrays, two rows of metalized cylinders or slots embedded in the dielectric substrate 103, or two metallic walls.

The metallic top layer 101a, the metallic bottom layer 101b, the two metallic side walls 114, and the layer of substrate 103 form a SIW, within which radio frequency (RF) waves propagate towards an antenna aperture 105, where the substrate 103 is exposed and not covered with any metallic layer or metallic wall.

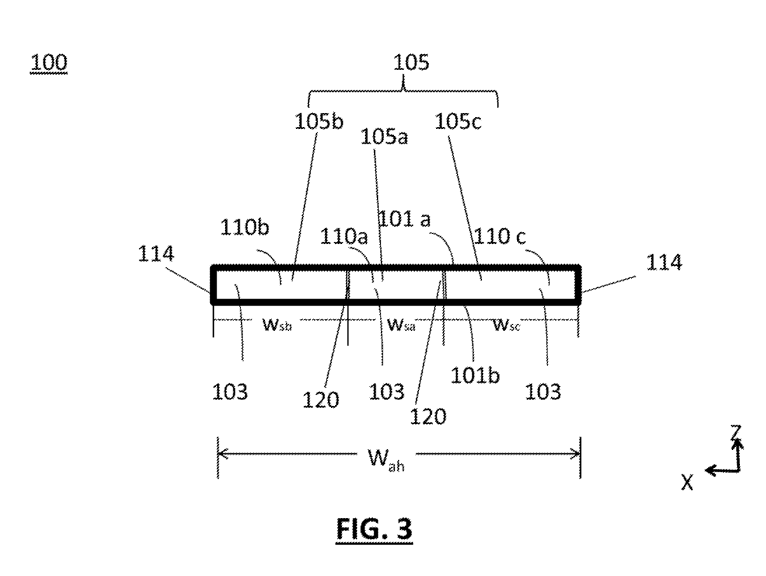

As illustrated in FIG. 1, the horn antenna 100 includes an input section 104 at a first end of the SIW and the antenna aperture 105 (FIG. 3) at a second end of the SIW, and a body 106 between the first and second ends. The body 106 is coupled to the input section 104 and the antenna aperture 105 for propagating RF waves from the input section 104 to the antenna aperture 105. The input section 104 functions as a waveguide, which may be an SIW straight structure, for receiving input RF waves from a source, for example, a coaxial cable or a waveguide. In some examples, conductive microstrip feeds 102 are provided on opposite sides of the substrate 103 to connect the input RF waves to the input section 104. The microstrip feed 102 provides an interface between existing RF circuits and the horn antenna 100. The microstrip feed 102 is electrically coupled to the input section 104 of the horn antenna 100, enabling RF waves received by the microstrip feed 102 to be fed into the input section 104 with little or no loss.

As propagation characteristics of RF waves in an SIW are similar to a rectangular waveguide, the width Wᵢ of the input section 104 meets the condition of a single mode transmission of a waveguide, namely, the width Wᵢ of the input section 104 allows RF waves of a specific mode with a frequency higher than a threshold frequency (“the cutoff frequency”) to propagate inside the waveguide with minimal attenuation. RF waves with a frequency lower than the cutoff frequency will be attenuated and will not propagate inside the waveguide.

The RF waves may be TEₙ₀ (Transverse Electric) mode, such as TE₁₀ mode. In an example, TE₁₀ mode is the dominant mode of the horn antenna 100, the cutoff frequency is:

$${f}_{c} = \frac{c}{2 a}$$

Where f_{c} is the waveguide cutoff frequency in Hz, c is the speed of light within the waveguide in meters per second, a is the internal dimension of the waveguide in meters. For example, a=Wᵢ of input section 104 so that the RF waves with frequency higher than the cutoff frequency f_{c} can be transmitted through the SIW.

In some examples, the cutoff wavelength λ_{c} can be used interchangeably with the cutoff frequency f_{c}. The cutoff wavelength is the maximum wavelength that will propagate in a waveguide, and λ_{c}=c/f_{c.}

In example embodiments, to have a desired wave beam width in YZ plane, the substrate 103 has a thickness of about 0.12λ, where λ is the central operating frequency of the horn antenna 100 and λ<=λ_{c}. The thicker the substrate 103 is, the narrower the wave beam in YZ plane. The height of the antenna aperture 105 in the Z-axis direction is substantially determined by the thickness of the substrate 103. The area of the aperture 105 typically is determined by the height and the width of the antenna aperture 105. The bigger the area of the aperture 105 is, the higher gain of the horn antenna 100.

At the antenna aperture 105, RF waves propagated inside the horn antenna 100 radiate to the free space. The total width Wₐₕ (FIG. 3) of the aperture 105 in X axis direction is equal or greater than W_{i.}

The body 106 of the horn antenna 100 is the portion between the input section 104 and the aperture 105. The body 106 flares RF waves into a beam, prepares the RF waves beam to be radiated at the antenna aperture 105 and adjusts the phase difference of the linearly polarized waves radiated by a plurality of radiating units of the horn antenna 100. In an example, the body 106 includes a flaring section 107 and an output section 108. The flaring section 107 is a flaring horn-shaped SIW to direct RF waves into a beam. The output section 108 is an SIW for preparing the waves beam to be radiated at the antenna aperture 105 and for adjusting the phase difference of the linearly polarized waves.

The body 106 of the horn antenna 100 includes a plurality of radiating units. In the example of FIG. 1, the body 106 of the horn antenna 100 includes three radiating units, for example, subhorns 110a, 110b, and 110c. In an example, the plurality of radiating units are arranged side by side and are substantially parallel to each other along X axis.

The radiating units 110a, 110b, and 110c may be formed on the body 106 by dividing the substrate 103 into a plurality of sections and adding further metallic dividing walls 120, such as metallic via arrays or metallic walls, between the two side walls 114. For example, radiating units 110a, 110b, and 110c in FIG. 1 are formed by dividing the body 106 of the horn antenna 100 into a plurality of radiating units with metallic dividing walls 120. In the example of FIG. 1, the metallic dividing walls 120, the portions of the top and bottom metallic layers between the side walls 114 and dividing walls 120, and the portions of the substrate enclosed therein form three sub-waveguides or three radiating units 110a, 110b, and 110c for the RF waves to propagate inside the horn antenna 100.

In some examples, odd number of metallic dividing walls 120, such as 1, 3, or 5, etc, are formed between the two side walls 114 to divide the body 106 of the horn antenna 100 into even radiating units, such as 2, 4, or 6, etc. For example, a metallic dividing wall 120 is formed in the middle of the two side walls 114 to substantially equally divide the body 106 into two radiating units. In other examples, even number of metallic dividing walls 120, such as 2, 4, or 6, etc, are formed between the two side walls 114 to divide the body 106 into odd number of radiating units, such as 3, 5, or 7, etc. For example, four metallic dividing walls 120 may be placed between the two side walls 114 and horn antenna 100 includes five radiating units in this case. In the case of even number of dividing walls 120, relative positions, structures, and shapes of metallic dividing walls 120 may be arranged to be substantially symmetrical to the axis a₀ of the aperture 105.

A metallic side wall 120 in FIG. 1 may be formed on two spaced-apart metallic walls. In this case, the metallic dividing wall 120 includes two spaced-apart metallic walls. Each metallic dividing wall 120 forms a side metallic wall of a radiating unit. Alternatively, the metallic dividing wall 120 is a single metallic wall shared by two adjacent radiating units.

In the examples of FIG. 1, each radiating units 110a, 110b, and 110c has an aperture 105a, 105b and 105c, respectively. The apertures 105a, 105b, and 105c are arranged along an edge of the substrate 103 (see FIG. 3). The edge is not covered with any metallic walls or layers. The width of the aperture 105a, 105b, and 105c of the radiating units is Wₛₐ, W_{sb}, and W_{sc}, respectively, and each of Wₛₐ, W_{sb}, and W_{sc}, is greater than 0.5λ of the RF waves to be radiated by the radiating units 110a, 110b, and 110c. As well, each of Wₛₐ, W_{sb}, and W_{sc} is greater than the cutoff wavelength of the central frequency.

The total width Wₐₕ=Wₛₐ+W_{sb}+W_{sc}. With a given Wₐₕ, the theoretical gain of the horn antenna 100 is determined. As illustrated in FIG. 1, the width Wₐₕ of the antenna aperture 105 is defined by the relative positions of the two side walls 114, and the relative positions of the metallic dividing walls 120 within the body 106 of the horn antenna 100 define the widths Wₛₐ, W_{sb}, and W_{sc} of the apertures 105a, 105b, 105c of the radiating units 110a, 110b, and 110c. As described above, the thickness of substrate 103 defines the height of the apertures 105a, 105b, 105c of the radiating units 110a, 110b, and 110c.

The horn antenna 100 in FIG. 1 is configured to radiate circularly polarized waves. Circular polarization refers a polarization state of an electromagnetic wave where electric field vector of the wave has a constant magnitude at each point, and the direction of the wave rotates with time at a steady rate in a plane perpendicular to the direction of propagation. To generate CP waves, the waves radiated from radiating units of the horn antenna 100 meet the following conditions:
1) the polarization directions of the electric field of the RF waves at the apertures of two radiating units are substantially orthogonal to obtain a wide 3 dB axial ratio (AR) beamwidth;
2) the amplitude of the orthogonal RF waves at the apertures of two radiating units in far field zone are substantially the same; and
3) the phase difference between the orthogonal RF waves at the apertures of two radiating unit in far field zone is substantially a 90 degree

In an example, the RF waves input into and propagate inside the horn antenna 100 are TE₁₀ mode, and the RF waves are vertically polarized waves (“vertical waves”). In TE₁₀ mode, the electric fields are transverse to the direction of propagation and no longitudinal electric field is present. TE₁₀ denotes that one half-wave pattern, namely, ½λ is across the width of the waveguide and no half-wave pattern is across the height of the waveguide.

In example embodiments of FIG. 1, the horn antenna 100 includes two types of radiating units: one radiates horizontally polarized waves (“horizontal waves”), namely that, polarization of electric fields of the RF waves is parallel to the substrate 103, evaluated in the far field; and the other radiates vertical waves, namely that, polarization of electric fields of the RF waves is vertical to the substrate 103, evaluated in the far field. Vertically and horizontally polarized waves are examples of linearly polarized waves.

In the example of FIG. 1, radiating unit 110a radiates horizontal waves (“horizontal radiating unit”), and functions as a horizontal antenna that generates horizontal waves. In the example of FIG. 1, the radiating unit 110a is an antipodal linearly tapered slot antenna (ALTSA) unit. The horizontal radiating unit 110a may also be a planar antenna generating horizontal waves, including, for example, a tapered slot antenna, a Vivaldi antenna, planar Yagi antenna, or planar log-periodic dipole antenna.

In FIG. 1, the radiating unit 110a includes a top tapered wing 112a formed on the metallic top layer 101a and a bottom tapered wing 112b formed on the metallic bottom layer 101b. The bottom tapered wing 120b is obscured by the substrate 103 and is illustrated with dash lines. The top tapered wing 112a connects to the top metallic layer 101a of radiating unit 110a, and the bottom tapered wing 112b connects to the bottom metallic layer 101b of the radiating unit 110a. In an example, each of the tapered wings 112a and 112b of horn antenna 100 has a tapered tip. The tapered tip may be formed by etching or cutting relevant portions of the metallic layer of the radiating unit 110a to form an ALTSA unit. The top and bottom tapered wings 112a and 112b flare linearly toward the opposite dividing walls 120. With the tapered wings 112a and 112b of the radiating unit 110a, which are parallel to the substrate 103, the polarization direction of the RF waves in radiating unit 110a is gradually rotated about 90 degrees at the aperture 105b. In other words, the RF waves of radiating unit 110a are rotated from vertical waves at the input section 104 of the horn antenna 100 to substantially horizontal waves at the aperture 105b.

In some example embodiments, the tapered wings 112a and 112b in FIG. 1 are substantially symmetrical to the each other with respect to the axis a₀ of the radiating unit 110a. The horn antenna 100 may include more than one ALTSA units, and each ALTSA unit has two tapered wings and one axis. In an example, one tapered wing is substantially symmetrical to the other tapered wing with respect to the axis of the ALTSA unit.

In the example of FIG. 1, if the input RF waves are TE₁₀ mode, the radiating units 110b and 110c do not change the polarization direction of the RF waves of TE₁₀ mode and radiate vertical waves (“vertical radiating units”). Each of the radiating units 110b and 110c functions as a vertical antenna that generates vertical waves.

The horn antenna 100 includes at least one horizontal radiating unit and one vertical radiating unit. In the example of FIG. 1, the body 106 of the horn antenna 100 includes one horizontal radiating unit 110a, and two vertical radiating units 110b and 110c. The two vertical radiating units 110b and 110c may be arranged on the two sides of the horizontal radiating unit 110a and substantially symmetrically with respect to the axis a₀ of the radiating unit 110a of the horn antenna 100. In some examples, the radiating unit 110a is configured as a vertical radiating unit and the radiating units 110b and 110c may be configured as horizontal radiating units and arranged symmetrically with respect to the axis a₀. In some example embodiments, the radiating units of the horn antenna 100 are arranged in such a manner that for every two adjacent radiating units, one radiating unit radiates vertical waves, and the other radiates horizontal waves. In another example, the axial ratio of the antenna 100 is less or equal to 3 dB.

In some examples, the horn antenna 100 include two types of radiating units: a first type of the radiating unit, such as radiating unit 110a, rotates the polarization direction of the input RF waves from an initial polarization direction Θ to a first degree Θ₁ at the aperture 105a of the first type radiating unit 110a, and a second type of the radiating unit, such as 110b or 110c, rotates the polarization direction of the input RF waves from the initial polarization direction Θ to a second degree Θ₂ at the aperture 105b or 105c of the second type radiating unit, so that the difference between polarization direction of Θ₁ and Θ₂ (Θ₁−Θ₂) is substantially +/−90°. For example, when the input RF waves is in TE₁₀ mode, the first type radiating unit rotates the input RF waves from vertical waves (Θ=90°) to a linearly polarized waves with a polarization direction of Θ₁(Θ₁=0°) at the aperture 105a of the first type radiating unit 110a, and the second type radiating unit rotates the input RF waves from vertical waves to a linearly polarized waves with a polarization direction of Θ₂ (Θ₂=90°) at the aperture 105b or 105c of the second type radiating unit 110b or 110c, and the difference between polarization direction of Θ₁ and Θ₂ is substantially +/−90°.

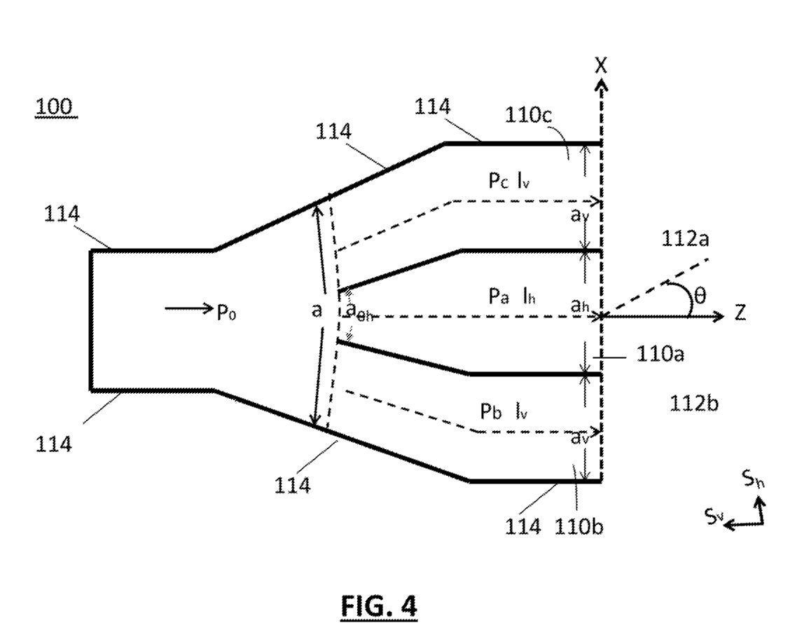

The amplitude of RF waves radiated from a radiating unit of the horn antenna 100 may be adjusted substantially the same by controlling the aperture width of the radiating unit. In the example of TE₁₀ mode, the RF wave has the highest wave input power or amplitude at the central axis of the aperture 105 of the horn antenna 100. In the example of FIG. 1, the central axis is the same as a₀ of the radiating unit 110a. The input power or amplitude of the input TE₁₀ mode RF waves in the body of the antenna 100 gradually decrease in the space farther away from the central axial direction a₀ of the antenna 100. As such, if the aperture width of the radiating units is the same, centrally located radiating unit 110a generally receives a higher input power or has higher amplitude of the RF waves compared to the lateral radiating units 110b and 110c. As radiating units 110b and 110c are symmetrical to the axis a₀ of the radiating unit 110a, the aperture width of radiating units 110b and 110c is substantially the same, namely that W_{sb}=W_{sc}. The wider is the aperture size of a radiating unit, the more power the radiating unit receives. The width of the aperture may be adjusted by the relevant positions of side walls 114 and 120. The principle of maintaining the amplitudes of the waves radiated from different polarized radiating units to be the same will be further discussed below in view of FIG. 4.

To generate phase difference of substantially a 90 degree in far field, the phase of the RF waves in a radiating unit may be controlled by adjusting the distance between the side walls 114 and/or dividing walls 120 of the radiating unit. If the distance between the two side walls of a radiating unit becomes narrower, the speed of the phase of the waves propagated inside the radiating unit will be faster. By adjusting the distance between the side walls of the radiating unit, 90 degrees phase difference between the two different polarized waves radiated from two differently polarized radiating units can be achieved at respective apertures of the two different polarized radiating units. For example, with the aid of a simulation software, such as CST Microwave STUDIO, in response to the change of distance between the side walls 114 and 120 of a radiating unit, the phase of the RF waves at the aperture of the radiating unit can be observed and therefore the desired distance can be determined. The principle of generating 90 degrees phase difference between the two different polarized waves radiated from two different radiating units will be further discussed below in view of FIG. 4.

In another embodiment, the phase of the RF waves radiated from a radiating unit may be further adjusted by further modifying a portion of a side wall 114 and/or 120 of the radiating unit. For example, a portion of a side wall 114 or dividing wall 120 on one side of a radiating unit may be further carved out so that the distance between the portion of the side wall and the corresponding portion of the corresponding side wall will become narrower. As such, only the phase of the waves radiated from the specific radiating unit has changed, and the phase of the waves radiated from the adjacent radiating unit is not affected. As illustrated in FIG. 1, a side wall 120 may be further carved into the radiating units 110c for the area of xyz, and a side wall 114 may be further carved into the radiating units 110c for the area of uvw. In this case, only the phase of the waves radiated from the radiating unit 110c has been changed, and the side wall 120 of the radiating unit 110a is not affected. As such, the phase of the RF waves radiated from the radiating unit 110a is not affected.

As well, to radiate a CP wave, the two radiation patterns generated by number of vertical radiating units and horizontal radiating units of the horn antenna 100, namely, the shapes of the waves radiated from the radiating units 110a and 110b, and from the radiating units 110c, are substantially the same, especially in the main lobes of the radiation pattern.

In an example, to radiate a CP wave in a far field, the two phase centers of the RF waves generated by the vertical radiating units and horizontal radiating units are coincided if the RF waves are viewed from the far field. For example, the phase centers of the RF waves are coincided if the waves are generated by an odd number radiating units. The horn antenna 100 performs better when the number of the radiating units is an odd number. With odd number of radiating units, the phase central points of the vertically polarized waves radiated from the vertical radiating units coincide at the phase central points of horizontal waves radiated from the horizontal radiating units in the far field.

The CP waves may rotate in a left sense or in a right sense. The arrangement of the tapered wings 112a and 112b of the radiating unit 110a in FIG. 1 produce CP waves rotating in the left sense. Exchanging the positions of the two tapered wings 112a and 112b of the radiating unit 110a in FIG. 1 changes the sense of the CP waves. In the example of FIG. 1, if tapered wing 112a is on the bottom and tapered wing 112b is on the top, the CP waves will rotate in right sense.

In addition to defining aperture width Wₛₐ, W_{sb}, and W_{sc} of radiating units 110a, 110b, and 110c, relative positions of metallic dividing walls 120 are related to the power ratio of these radiating units. As illustrated in FIG. 1, the body 106 of the horn antenna 100, which may include the flaring section 107 and the output section 108, together with the side walls 114 and 120, divide the initial input power P₀ of the RF waves into three portions: Pₐ in radiating unit 110a, P_{b} in radiating unit 110b, and P_{c} in radiating unit 110c.

Reference is made to FIG. 4. The relationship between the input power of the horizontal radiating unit 110a for generating horizontal RF waves for the dominant mode TE₁₀, which is an example of TEₙ₀ and the radiating units 110b and 110c for generating vertical RF waves for the dominant mode TE₁₀ can be deduced in equation (1) below. For a dominant mode TE₁₀, the receiving power P₀ of the body 106 is expressed as

$${P}_{0} = \frac{{E}_{0}^{2} ha}{4 Z} \qquad ( 1 )$$

where h is the thickness of substrate 103, a is the width of the flaring section 107 at the opening of the radiating units 110a 110b and 110c as illustrated in dotted line. E₀ is the maximum value of electric field at the opening of the radiating units 110a, 110b and 110c. Z is the wave impedance of the substrate 103 in free space, for which

$$Z = \sqrt{\frac{μ}{ɛ}} \qquad ( 2 )$$

where μ and ε are permeability and permittivity of the substrate 103, respectively.

The body 106 is divided into the radiating units 110a, 110b and 110c, and Pₐ is the input power of radiating units 110a (Pₐ in FIGS. 1 and 4), for which

$${P}_{a} = \frac{{E}_{0}^{2} ha}{4 Z π} [ \frac{π {a}_{0 h}}{a} + sin \frac{π {a}_{0 h}}{a} ] \qquad ( 3 )$$

where a₀ₕ is the opening width of the radiating units 110a. The input power P_{b} of radiating units 110b (P_{b} in FIG. 1) is

$${P}_{b} = \frac{{P}_{0} - {P}_{a}}{2} \qquad ( 4 )$$

The input power P_{c} of radiating units 110c (P_{c} in FIG. 1) is the same as P_{b}. From (1) and (3) we have

$${P}_{b} = \frac{{E}_{0}^{2} ha}{4 Z π} [ \frac{π}{2 a} ( a - {a}_{0 h} ) - \frac{1}{2} sin \frac{π {a}_{0 h}}{a} ] \qquad ( 5 )$$

Let Sₕ to be the density of power flux of the radiating wave in the far field zone from radiating units 110a, and Sₕ is expressed as

$${S}_{h} = \frac{{P}_{a} {G}_{h}}{4 π {r}^{2}} {f}_{h} ( θ , ϕ ) \qquad ( 6 )$$

where r is the distance from the horn antenna 100 to the far field zone, Gₕ is the power gain of radiating units 110a, and fₕ(θ,φ) is the normalized directivity of radiating units 110a. θ (see FIG. 4) and φ are spatial angles of the radiated RF waves.

Radiating units 110b and 110c radiate vertically polarized wave and function as a two-element antenna array. Let Sᵥ to be the density of power flux of radiating units 110b and 110c in the far-field zone, and Sᵥ can be deduced as follows:

$${S}_{v} = \frac{2 {P}_{b} {G}_{v}}{4 π {r}^{2}} 2 {cos}^{2} ( 0.5 k ( {a}_{h} + {a}_{v} ) sin θ ) {f}_{v} ( θ , ϕ ) \qquad ( 7 )$$

Where Gᵥ is the power gain of radiating unit 110b or 110c, and fᵥ(θ,φ) is the normalized directivity of radiating unit 110b or 110c. k is wave number in free space, aₕ (Wₛₐ in FIG. 3) is the aperture width of radiating units 110a, and aᵥ (W_{sb} and W_{sc} in FIG. 3) is the aperture width of the lateral radiating units 110b or 110c.

Because radiating units 110a, 110b and 110c reach the maximum radiation in endfire direction, namely, along the axis a₀ of horn antenna 100, the fₕ(θ,φ) and fᵥ(θ,φ) are 1 when θ=0 and φ=0. To be a CP wave, Sₕ and Sᵥ should be the same when θ=0 and φ=0. Based on equations (6) and (7), it gives

PₐGₕ=4P_{b}Gᵥ (8)

Combining (3) and (5) into (8) gives

$$[ \frac{π {a}_{0 h}}{a} + sin \frac{π {a}_{0 h}}{a} ] {G}_{h} = 2 [ π ( 1 - \frac{{a}_{0 h}}{a} ) - sin \frac{π {a}_{0 h}}{a} ] {G}_{v} \qquad ( 9 )$$

Therefore, by properly selecting the width of the flaring section 107 (a) at the opening of the radiating units 110a 110b and 110c, opening width of the radiating units 110a (a₀ₕ), the power gains of radiating units 110a (Gₕ), and radiating unit 110b and 110c (Gᵥ), Sₕ and Sᵥ can be substantially the same.

As described above, where all conditions to generate CP waves are met, Sₕ and Sᵥ are substantially the same within the range of the main lobe of radiation pattern at a spatial angle with respect to the axis a₀ of the horn antenna 100. Accordingly, a circularly polarized wave may be generated over a wide range of spatial angle θ. Sₕ and Sᵥ are substantially the same within the range of the main lobe of radiation pattern at a spatial angle with respect to the axis a₀ of the horn antenna 100. Accordingly, an objective function may be defined for the design of the CP horn antenna 100, which is Min|Sₕ−Sᵥ|. Based on equations (3) to (8), the objective function can be rewritten as follows:

Min|fₕ(θ,φ)−cos²(0.5k(aₕ+aᵥ)sin θ)fᵥ(θ,φ)| (10)

The objective function (10) concerns the span of the spatial angles θ and φ on both XZ and YZ planes. As described above, if an aperture is wider in a plane, wave beam generated in the plane is narrower. In the example of the horn antenna 100 in FIG. 1, the apertures of radiating units 110a, 110b, and 110c in YZ plane are narrower than in the XZ plane. As such, both radiating units 110b and 110c have wider beams on the YZ plane than on the XZ plane. Radiating units 110b and 110c effectively form a two-element array to narrow the beam on the XZ plane. From the far field, because of the odd numbers of radiating units, the central radiating unit 110a and the array of two radiating units 110b and 110c have the same phase center along the axis a₀ of the aperture of radiating unit 110a of the horn antenna 100.

In addition to substantial equality in amplitudes of the RF waves generated from radiating units 110a, 110b, and 110c, a phase difference of 90 degrees may be achieved over an operating frequency range, for example, 24 GHz. The phase difference along the length of radiating units 110b and 110a can be written as follows

φ=βᵥlᵥ−βₕlₕ (11)

where, as illustrated in FIG. 4, is the distance that the waves propagated inside the radiating units 110b and 110c with the propagation constants of βᵥ; and lₕ is the distance that the waves propagated inside the radiating unit 110awith the propagation constants βₕ. βᵥ and βₕ are determined by the medium of substrate 103 in respective radiating units 110a, 110b, and 110c. To generate circularly polarized RF waves, the phase difference between the radiating units 110a and 110b or between the radiating units 110a and 110c is substantially 90 degrees (90°), therefore

$${β}_{v} {l}_{v} - {β}_{h} {l}_{h} = n π \pm \frac{π}{2} \qquad ( 12 )$$

As such, by properly selecting the medium of substrate 103 and the lengths of respective radiating units, the phase difference of substantially 90 degrees (90°) between the vertical and horizontal radiating units can be achieved.

On the other hand, the speed of the phase difference variation should remain as small as possible when the frequency of operation changes, so that the phase difference is insensitive to the change of the frequency of the waves. Since

$$\begin{matrix}{β}_{v} = \frac{2 π}{λ} \sqrt{1 - {( \frac{λ}{2 {a}_{v}} )}^{2}} & ( 13 ) \\ and & \\ {β}_{h} = \frac{2 π}{λ} \sqrt{1 - {( \frac{λ}{2 {a}_{h}} )}^{2}} & ( 14 )\end{matrix}$$

The speed of the phase difference variation can be formulated as follows:

$$\frac{d ϕ}{d λ} = - \frac{2 π}{{λ}^{2}} {l}_{v} \sqrt{1 - {( \frac{λ}{2 {a}_{v}} )}^{2}} - \frac{2 π}{λ} {l}_{v} \frac{1}{\sqrt{1 - {( \frac{λ}{2 {a}_{v}} )}^{2}}} \frac{λ}{4 {a}_{v}^{2}} + \frac{2 π}{{λ}^{2}} {l}_{h} \sqrt{1 - {( \frac{λ}{2 {a}_{h}} )}^{2}} + \frac{2 π}{λ} {l}_{h} \frac{1}{\sqrt{1 - {( \frac{λ}{2 {a}_{h}} )}^{2}}} \frac{λ}{4 {a}_{h}^{2}} \qquad ( 15 )$$

Based on equations (15) and (12), the speed of the phase difference variation in terms of the frequency can be derived as follows:

$$λ \frac{d ϕ}{d λ} = ( n \pm \frac{1}{2} ) {π}^{2} + \frac{π}{2} ( \frac{{l}_{v} {λ}_{gv}}{{a}_{v}^{2}} - \frac{{l}_{h} {λ}_{gh}}{{a}_{h}^{2}} ) \qquad ( 16 )$$

in which parameters λ_{gv} is the average guided wavelength in the radiating units 110b and 110c, λ_{gh} is the average guided wavelength in the radiating units 110a, and n is an integer.

In practice, the second term in the right side of equation (16) would be smaller than the first term if the absolute value of n in the first term is large enough. Therefore, the absolute value of n should be as small as possible in order to keep the speed of the phase difference variation as small as possible and to preserve the 90 degree phase difference. For example, n=0.

As described above, the side walls 114 and dividing walls 120 define the shape of the radiating units 110a, 110b, and 110c. As well, the relative positions of the side walls 114 and 120 are related to the phase and amplitude of the waves radiated from the radiating units. In order to keep the radiation pattern of the central radiating unit 110a and lateral radiating units 110b and 110c as similar as possible, a commercial or customized software package may be used to determine the desired shape and position of the side walls 114 and 120, based on the equations (8) and (14) to simulate the waves radiated from the radiating units. With the simulation results, relative positions or width of the side walls may be further adjusted, for example, with carved out portion xyz and uvw of radiating unit 110c, as described above.

Using the SIW technology, the horn antenna 100 may be manufactured by using a printed circuit board (PCB) design process, which is a low-cost standard technology, or by using other fabrication techniques to design and implement large-scale substrate integrated circuits (SICs). As well, H-plane SIW horn antennas, for example, antipodal linearly tapered slot antennas (ALTSA), are commonly used for SICs-related applications.

For example, the horn antenna 100 may be manufactured on a dielectric substrate 103, such as a printed circuit board (PCB). The substrate 103 has a top side and a bottom side. The top side and the bottom side of the substrate 103 may be covered with conductive layers, such a top metallic layer 101a and a bottom metallic layer 101b, respectively. In an embodiment, the metallic layers may be copper plates. In another embodiment, the conductive layers may be printed or coated on the substrate 103, for example, by a 3D metal printer. Tools, such as laser, may be used to cut through the top metallic layer 101a, the substrate 103, and the bottom metallic layer 101b according to the simulated positions and shapes of side walls 114 and 120 to form channels, which define the shapes of horn antenna 100 and respective radiating units 110a, 110b, and 110c. The relevant left and right sides of the channels are metalized with metallic via array technology or metallic walls technology for forming metallic side walls 114 and dividing walls 120. As such, each of the radiating units 110a, 110b, and 110c of horn antenna 100 forms a waveguide with the relevant portions of metallic layers 101a and 101b, the substrate 103, and relevant side walls 114 and dividing walls 120. An edge of the substrate 103 uncovered with any metallic layer provides the apertures 105a, 105b, 105c of the radiating unit 110a, 110b, and 110c. The tapered wings of ALTSA units, such as 112a and 112b of horn antenna 100 may be formed by etching or cutting relevant portions of the metallic layer of the relevant radiating units to form one or more ALTSA units for rotating polarization directions of the RF waves. Relevant portions of the metallic layer cut away may be determined with the aid of commercially available software. The portion of the substrate 103 between the relevant portions of the metallic layer of the ALTSA units is not cut away to keep the medium property between the metallic layers of the ALTSA radiating unit unchanged. The order of the steps to form the horn antenna 100 is only illustrative but not restrictive and it may be modified.

With the SIW technology, the horn antenna 100 may be formed on one layer of substrate 103. As well, because all elements of an SIW are on a single layer substrate 103, the SIW is easier to manufacture and the overall size and cost of the horn antenna 100 can be reduced. In addition, as the horn antenna 100 is substantially in a planar form, this allows the horn antenna 100 to be integrated in the applications involving substrate integrated circuits (SICs). As well, the number of radiating units of the horn antenna 100 can be increased to achieve a potential higher gain.

### Performance of the Horn Antenna

By selecting proper type of radiating units, such as ALTSA radiating unit, a higher gain of the horn antenna 100 may be achieved even the layer of substrate 103 has a thickness of 0.12λ. In at least some applications, simulation results have indicated that horn antenna 100 at 24 GHz central frequency has a high gain. According to simulation results, horn antenna 100 having ALTSA as horizontal radiating unit has 8 dB gain in most of the 22.5 GHz to 25.5 GHz. On the other hand, if electric current ring or the dipole is used as horizontal radiating unit, the gain of the antenna will be lower, for example, about 2 dB.

Horn Antenna 100 has a good impedance matching with the output impedance of a transceiver. According to simulation results, horn antenna 100 has a scattering parameter S_{Rx-Rx} equal or substantially less than −10 dB in most of the frequency range of 22.5 GHz to 25.5 GHz.

Horn Antenna 100 generates CP waves in the frequency range 23.7 GHz to 25.15 GHz. According to simulation results, horn antenna 100 has an axial ratio less or equal to 3 dB in the frequency range 23.7 GHz to 25.15 GHz.

As well, horn Antenna 100 has a good directivity. According to simulation results, power density of the horn antenna 100 is concentrated in vertical plane (ZY plane) about −30° to 30°, power density of the horn antenna 100 is concentrated in horizontal plane (XZ plane) is about −15° to 15°.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, while the systems, devices and processes disclosed and shown herein may comprise a specific number of elements/components, the systems, devices and assemblies could be modified to include additional or fewer of such elements/components. For example, while any of the elements/components disclosed may be referenced as being singular, the embodiments disclosed herein could be modified to include a plurality of such elements/components. The subject matter described herein intends to cover and embrace all suitable changes in technology.

1. An end fire circularly polarized (CP) substrate integrated waveguide (SIW) horn antenna, comprising:
an input section for receiving radio frequency (RF) waves from a source; and
a body extending from the input section for receiving the RF waves from the input section, the body comprising a plurality of radiating units, the plurality of radiating units being configured to radiate circularly polarized waves (CP) in a far field,
wherein apertures of the plurality of radiating unit being located along an edge of a planar dielectric substrate, and wherein the horn antenna is in a planar form.

2. The antenna of claim 1, wherein the plurality of radiating units radiating corresponding RF waves from respective radiating unit apertures, the plurality of radiating units comprising a first radiating unit for radiating first linearly polarized waves, and a second radiating unit for radiating second linearly polarized waves, wherein at respective radiating unit apertures of the first and second radiating units, the first linearly polarized waves and the second linearly polarized waves have a substantially same amplitude, a phase difference of substantially 90°, and a difference in polarization direction of substantially +/−90°.

3. The antenna of claim 2, wherein the first linearly polarized waves are vertically polarized waves.

4. The antenna of claim 2, wherein the second linearly polarized waves are horizontally polarized waves.

5. The antenna of claim 1, wherein the radiating units are subhorns.

6. The antenna of claim 2, wherein at least one of the first and second radiating units is an antipodal linearly tapered slot antenna (ALTSA).

7. The antenna of claim 1, further comprising a microstrip feed electrically coupled to the input section, the microstrip feed receiving and feeding the RF waves to the input section.

8. The antenna of claim 1, wherein the input section is an SIW straight structure.

9. The antenna of claim 1, wherein the plurality of radiating units are formed by dividing the body with metallic walls.

10. The antenna of claim 1, wherein the plurality of radiating units are formed by dividing the body with metal via array.

11. The antenna of claim 1, wherein the plurality of radiating units are an odd number.

12. The antenna of claim 2, wherein circularly polarized waves formed by the first linearly polarized waves and the second linearly polarized waves rotate in a left sense.

13. The antenna of claim 1, wherein a width of each of the respective radiating unit apertures is larger than 0.5λ of the RF waves to be radiated by the radiating units, and wherein λ is a wavelength of the RF waves at a central operating frequency.

14. The antenna of claim 1, wherein the substrate has a thickness of about 0.12λ, and wherein λ is a wavelength of the RF waves at a central operating frequency.

15. The antenna of claim 11, wherein the radiating units comprises a central radiating unit, and other radiating units are arranged symmetrically with respect to the central radiating unit.

16. The antenna of claim 15, wherein the central unit radiates horizontally polarized waves.

17. The antenna of claim 15, wherein the central unit radiates vertically polarized waves.

18. The antenna of claim 1, wherein the axial ratio of the horn antenna is less or equal to 3 dB.

19. The antenna of claim 2, wherein the first radiating unit is adjacent to the second radiating unit.

20. The antenna of claim 1, wherein the input section and the body are formed from the planar dielectric substrate enclosed by planar conductive layers on opposite sides thereof and two conductive side walls electrically connecting the planar conductive layers.

21. A method of manufacturing an end fire circularly polarized (CP) horn antenna on a substrate having a face side and a bottom side, comprising:
covering the face side of the substrate with a face side conductive layer;
covering the bottom side of the substrate with a bottom side conductive layer;
forming conductive side walls for electrically connecting the face side conductive layer and the bottom side conductive layer;
forming a plurality channels by cutting or etching through the face conductive layer, the substrate, and the bottom conductive layer; and
forming conductive dividing walls by metalizing two surfaces of each of the channels, wherein the top and bottom conductive layers, the conductive side walls, the conductive dividing walls, and the substrate form the horn antenna comprising a plurality of radiating units,
wherein the plurality of radiating units radiate circularly polarized waves in a far field, and wherein the horn antenna is in a planar form.

22. The method of claim 21, wherein at least one radiating unit is an antipodal linearly tapered slot antenna (ALTSA).

23. The method of claim 21, further comprising adjusting positions and shapes of a portion of a conductive dividing wall.
